(19) United States
(12) Patent Application Publication
(10) Pub. No.: US 2014/0197652 A1
(43) Pub. Date: Jul. 17, 2014

(54) END EFFECTOR MODULE

(71) Applicant: PRECISION MACHINERY REAEARCH & DEVELOPMENT CENTER, (US)

(72) Inventors: PEI-JUI WANG, HSINCHU CITY (TW); CHE-HAU WU, KAOHSIUNG CITY (TW)

(73) Assignee: PRECISION MACHINERY RESEARCH & DEVELOPMENT CENTER, TAICHUNG (TW)

(21) Appl. No.: 13/741,445

(22) Filed: Jan. 15, 2013

(51) Int. Cl. B25J 15/06; B25J 15/00

(52) U.S. Cl. 294/185; 294/188; 901/40

(57) ABSTRACT

An end effector module includes a palm base and robotic fingers extended from the palm base. Each robotic finger is composed of four joint shafts pivotally coupled with one another, and one of the four joint shafts, namely a start joint shaft, has a driving mechanism for driving a corresponding robotic finger to rotate, and each joint shaft has a driving mechanism to drive a next corresponding joint shaft to turn pivotally and bend with respect to other corresponding joint shafts, so that each robotic finger is module with four degrees of freedom for fine-tuning the position of a suction device installed at an end joint shaft, and the suction device can move along the normal direction of a suction point selected on the surface of a clamped object to achieve the effect of clamping and sucking an object securely without the risk of being loosened easily.

### FIELD OF THE INVENTION

The present invention relates to an end effector module, in particular to the end effector module having a plurality of joint shafts and a driving device installed at each joint shaft and provided for driving and fine-tuning the joint shafts to facilitate clamping and sucking an object from different oriented surfaces.

### BACKGROUND OF THE INVENTION

In a conventional end effector structure as disclosed in U.S. Pat. No. 5,501,498, the frictional force between an end joint shaft of a robotic finger and an object is used for clamping the object, but the clamping effect is relatively low due to factors such as the clamping angle, the size and the surface smoothness of the object.

In another conventional end effector structure as disclosed in U.S. Pat. Publication No. 2010/0156125, a combination of air pressure, a link rod and a spring is provided to drive a robotic finger to turn pivotally in order to achieve the operation of clamping an object, and the conventional end effector has a suction device installed at an end of a joint shaft for sucking the object by a suction, and this structure overcomes the drawback of the aforementioned conventional end effector structure.

However, this conventional end effector structure has three joint shafts of each robotic finger, which is similar to a human finger that can be bent in sections, and an end joint shaft comes with a suction design, so that the robotic finger can be bent or pivotally turned in a direction towards a palm similar to that of human fingers. In other words, the motion of the robotic finger has only one degree of freedom and fails to make a fine angular adjustment of the joint shaft, and it is relatively difficult to move a suction device to a position corresponding to the normal direction of the surface of the object or approach a selected suction point along the normal direction to suck the object. As a result, such conventional end effector structure has a low clamping effect. In summation, this conventional end effector is applicable for grasping or sucking an object of a special shape and incapable of selecting the suction point precisely according to the direction of approaching an object in the normal direction and clamping the object.

In another conventional end effector structure as disclosed in Japan Pat. Publication No. P2010-155331A, a special design of a suction device and its robotic hand is adopted, so that a suction device can approach the normal direction to suck the object precisely, but the robotic hand is a fixed structure and incapable of clamping or sucking objects of different shapes.

### SUMMARY OF THE INVENTION

In view of the aforementioned problems, it is a primary objective of the present invention to provide an end effector module that drives a gear by a motor installed at each joint shaft in order to drive a whole robotic finger to rotate while driving another gear to drive the next joint shaft to bend, so that the robotic finger of the present invention has a plural degrees of freedom and is applicable for clamping and sucking various objects with different oriented surfaces through a suction device installed at the end of each joint shaft.

To achieve the foregoing objective, the present invention provides an end effector module, comprising: a palm base, a plurality of robotic fingers, extended from a same side of the palm base, and each robotic finger being formed by sequentially and pivotally coupling a start joint shaft, a first middle joint shaft, a second middle joint shaft and an end joint shaft with each other, wherein: the start joint shaft has a first driving mechanism for driving the first middle joint shaft to turn pivotally and bend with respect to the start joint shaft, as well as driving the first middle joint shaft to turn the second middle joint shaft and the end joint shaft altogether; the first middle joint shaft has a second driving mechanism for driving the second middle joint shaft to turn pivotally and bend with respect to the first middle joint shaft; the second middle joint shaft has a third driving mechanism for driving the end joint shaft to turn pivotally and bend with respect to the second middle joint shaft; thereby, each robotic finger is bent by the rotation of the robotic finger and the pivotal turning of each joint shaft to adjust the position of a suction device installed on the end joint shaft, so as to move the suction device to the normal direction of a selected suction point of a surface of a clamped object and approach the normal direction to suck the object.

### BRIEF DESCRIPTION OF THE DRAWINGS

FIG. 1 is a perspective view of a preferred embodiment of the present invention;

FIG. 2 is an exploded view of a robotic finger of the present invention;

FIG. 3 is a partial blow-up view of a section between a start joint shaft and a first middle joint shaft of the present invention;

FIG. 4 is a schematic view, showing an operation of controlling a joint shaft to bend in accordance with the present invention;

FIGS. 5 and 6 for schematic views, showing an operation of controlling a joint shaft to rotate and bend simultaneously in accordance with the present invention;

FIG. 7 is a schematic view, showing an operation of controlling a joint shaft to rotate in accordance with the present invention; and

FIG. 8 is a schematic view, showing an operation of clamping and sucking an object in accordance with the present invention.

### DESCRIPTION OF THE PREFERRED EMBODIMENTS

The technical characteristics of the present invention will become apparent with the detailed description of the preferred embodiments accompanied with the illustration of related drawings as follows.

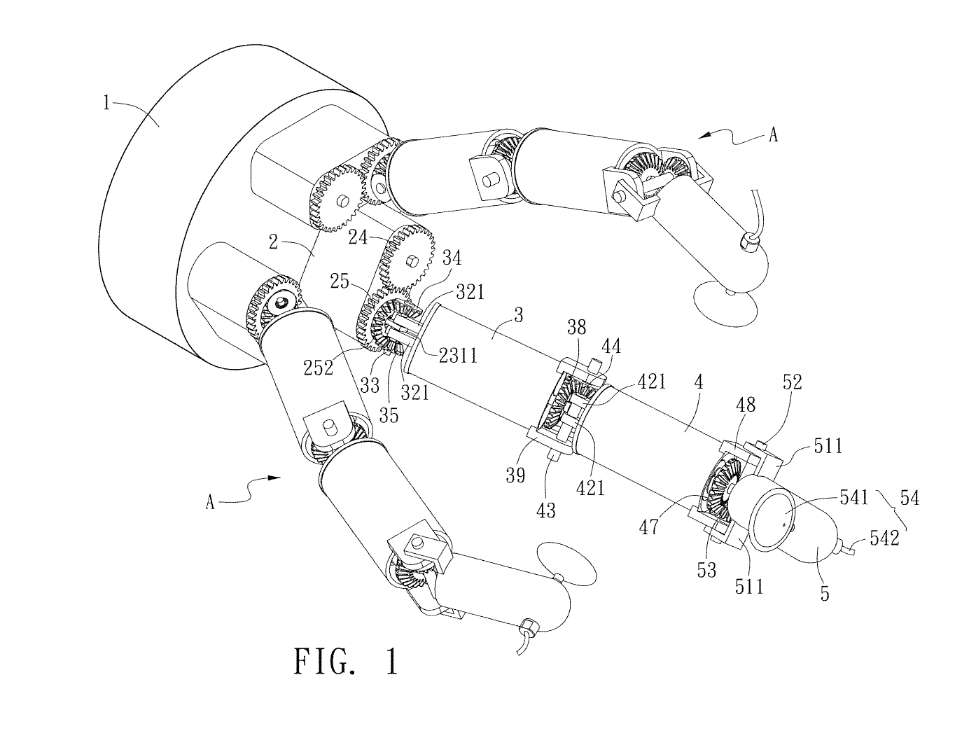

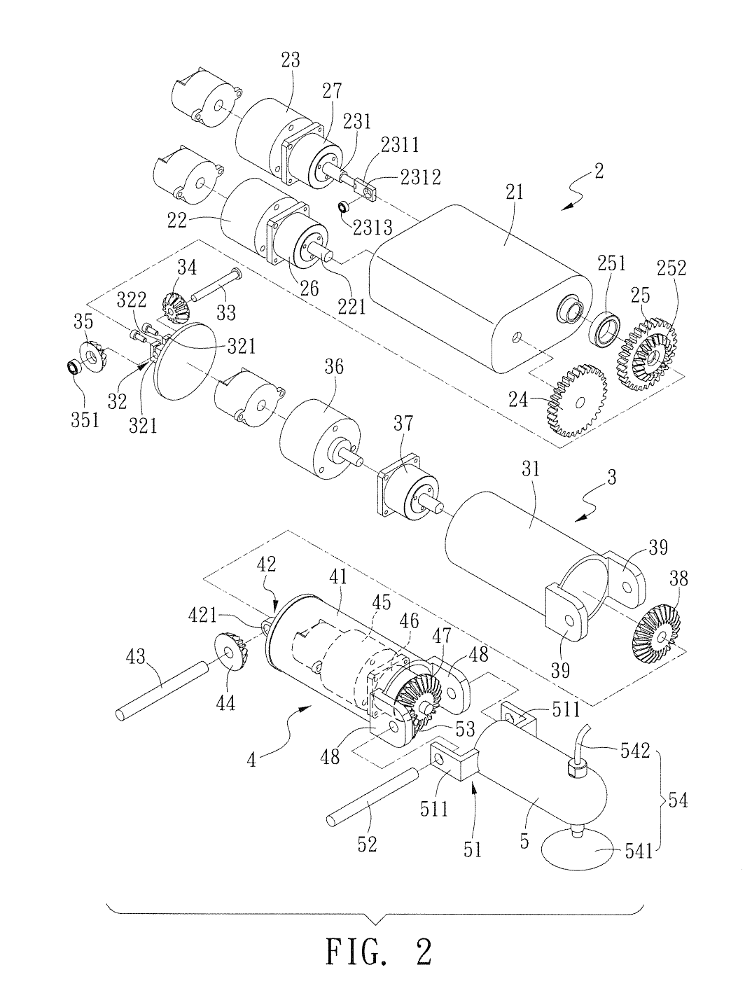

With reference to FIGS. 1 and 2 for an end effector module of the present invention, the end effector module comprises a palm base 1, and a plurality of robotic fingers A extended from a same side of the palm base 1, wherein each robotic finger A is formed by sequentially and pivotally coupling a start joint shaft 2, a first middle joint shaft 3, a second middle joint shaft 4 and an end joint shaft 5, and the structure of each of the joint shafts is described as follows.

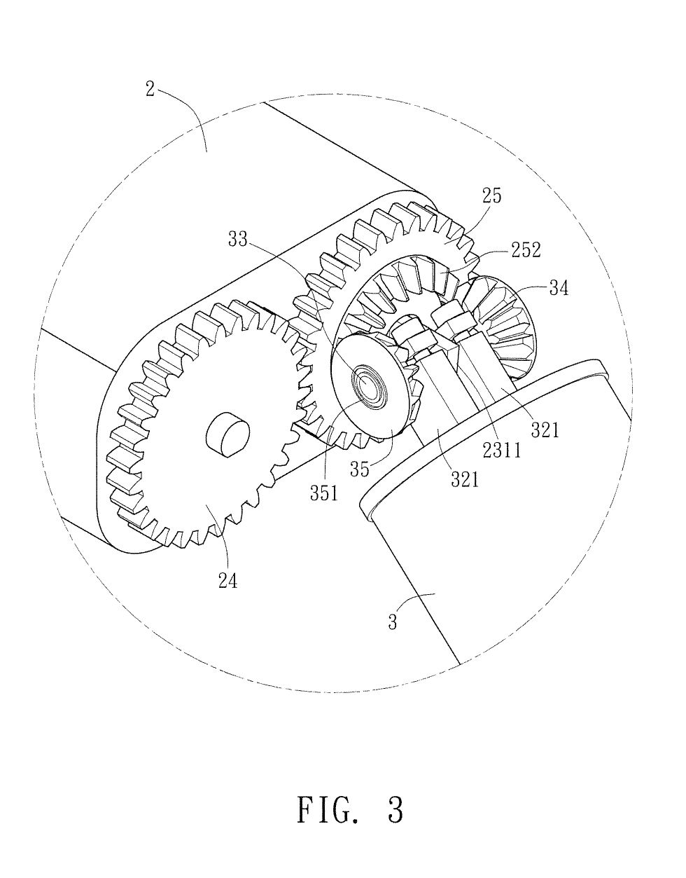

The start joint shaft 2 is extended from the palm base 1 and has a casing 21, and a first motor 22 and a second motor 23 installed on adjacent sides of the casing 21 respectively, wherein a first transmission shaft 221 is extended from the first motor 22, and a second transmission shaft 231 is extended from the second motor 23, and the first transmission shaft 221 is axially fixed to an active gear 24, such that the first motor 22 can drive the active gear 24 to rotate directly, and the second transmission shaft 231 has a passive gear 25 pivotally coupled by a bearing 251, such that the second motor 23 does not drive the passive gear 25 to rotate directly. In this preferred embodiment, each of the first motor 22 and the second motor 23 is coupled to a speed reducer 26, 27 first, and then coupled to the corresponding gear 24, 25 for adjusting the rotation speed of each gear 24, 25 driven by the motor. In FIGS. 2 and 3, the active gear 24 and the passive gear 25 are engaged with each other, and the active gear 24 drives the passive gear 25 to rotate, and the passive gear 25 has a first bevel gear 252 fixed onto a disc surface of the passive gear 25 and synchronously rotated together with the passive gear 25. In addition, the second transmission shaft 231 is passed through the passive gear 25 and the first bevel gear 252 and has a connecting end 2311 with a pivot hole 2312 formed thereon. In this preferred embodiment, the pivot hole 2312 contains a bearing 2313.

The first middle joint shaft 3 also has a casing 31 with a connecting portion 32 formed at an end, and the connecting portion 32 is composed of a pair of columns 321 arranged with an interval apart from one another and a pivot 33 is transversely passed through the two columns 321 and a gap 322 between the two columns 321 to fix with the connecting portion 32, and the connecting end 2311 of the second transmission shaft 231 is extended into the gap 322, and the pivot 33 is passed through the pivot hole 2312 of the connecting end 2311 and rotated in the pivot hole 2312, so as to drive the first middle joint shaft 3 to turn pivotally. A second bevel gear 34 is pivotally coupled to an end of the pivot 33 and engaged with the first bevel gear 252, and the second bevel gear 34 can be driven to rotate through the transmission by the first motor 22, so that the rotation of the first transmission shaft 221, the active gear 24, the passive gear 25 and the first bevel gear 252, and the pivot 33 is driven to rotate to turn the first middle joint shaft 3 pivotally. In this preferred embodiment, the pivot 33 of the connecting portion 32 of the first middle joint shaft 3 has a seventh bevel gear 35 installed at a position opposite to the second bevel gear 34 by a bearing 351 and engaged with the first bevel gear 252 for balancing the rotational inertia of the second bevel gear 34 on the pivot 33, wherein the seventh bevel gear 35 can be driven by the first bevel gear 252 to rotate idly with respect to the pivot 33 without affecting the overall operation of the end effector. The first middle joint shaft 3 includes a third motor 36 installed in a casing 31 of the first middle joint shaft 3 and coupled to a speed reducer 37 and then coupled to a third bevel gear 38, and the casing 31 of the first middle joint shaft 3 has a pivoting portion 39 disposed at a position proximate to the third bevel gear 38 for downwardly and pivotally coupling the second middle joint shaft 4.

The second middle joint shaft 4 also has a casing 41 with a connecting portion 42 disposed at an end, and the connecting portion 42 is composed of a pair of columns 421 arranged with an interval apart, and a transverse pivot 43 is installed on the two columns 421 and passed through the pivoting portion 39 of the first middle joint shaft 3, so that the second middle joint shaft 4 can be turned pivotally with respect to the first middle joint shaft 3, and the pivot 43 has a fourth bevel gear 44 engaged with the third bevel gear 38, such that the rotation of the third bevel gear 38 can drive the fourth bevel gear 44 to rotate the pivot 43, so as to turn the second middle joint shaft 4 pivotally. In addition, the second middle joint shaft 4 has a fourth motor 45 installed in the casing 41 and coupled to a speed reducer 46 and then coupled to a fifth bevel gear 47, and the casing 41 of the second middle joint shaft 4 has a pivoting portion 48 disposed at a position proximate to the fifth bevel gear 47 for downwardly and pivotally coupling the end joint shaft 5.

A connecting portion 51 is formed at an end of the end joint shaft 5 and composed of a pair of wing portions 511 disposed at both sides of the end joint shaft 5 respectively, and a transverse pivot 52 is fixed onto the two wing portions 511 and passed through the pivoting portion 48 of the second middle joint shaft 4, so that the end joint shaft 5 can be turned pivotally with respect to the second middle joint shaft 4, and the pivot 52 has a sixth bevel gear 53 engaged with the fifth bevel gear 47, such that the rotation of the fifth bevel gear 47 drives the sixth bevel gear 53 to rotate the pivot 52, so as to turn the end joint shaft 5 pivotally. In addition, the end joint shaft 5 has a suction device 54 installed at an end opposite to the connecting portion 51 for sucking a surface of an object to provide a more secured grasp.

In one of the robotic fingers of the end effector module in accordance to a preferred embodiment of the present invention as shown in FIG. 1, the end effector module is comprised of a palm base 1 and three robotic fingers A, and the motor installed in each joint shaft drives the operations of each joint shaft such as the rotation of robotic finger A and the bending movement of each joint shaft, and the foregoing movements are described as follows.

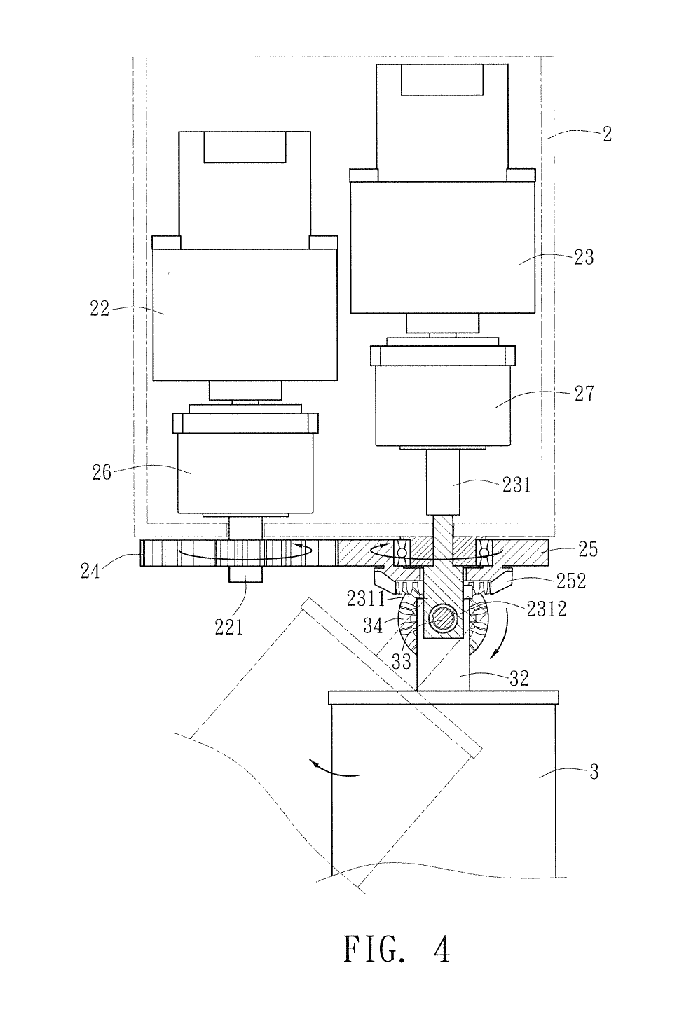

1. In FIG. 4, when the first motor 22 is operated but the second motor 23 is not operated, the first motor 22 drives the active gear 24 to rotate through the first transmission shaft 221 of the first motor 22, and further drives the engaged passive gear 25, so that the first bevel gear 252 installed thereon is rotated synchronously to drive the second bevel gear 34 of the first middle joint shaft 3, so that the pivot 33 fixed to the connecting portion 32 of the first middle joint shaft 3 can be rotated pivotally in the pivot hole 2312 of the connecting end 2311 of the second transmission shaft 231, so as to drive the first middle joint shaft 3 to turn pivotally with respect to the start joint shaft 2 to produce a bending movement. It is noteworthy that the second middle joint shaft and the end joint shaft are bent by changing the transmission direction of the motor by the bevel gear, which will not be described in details.

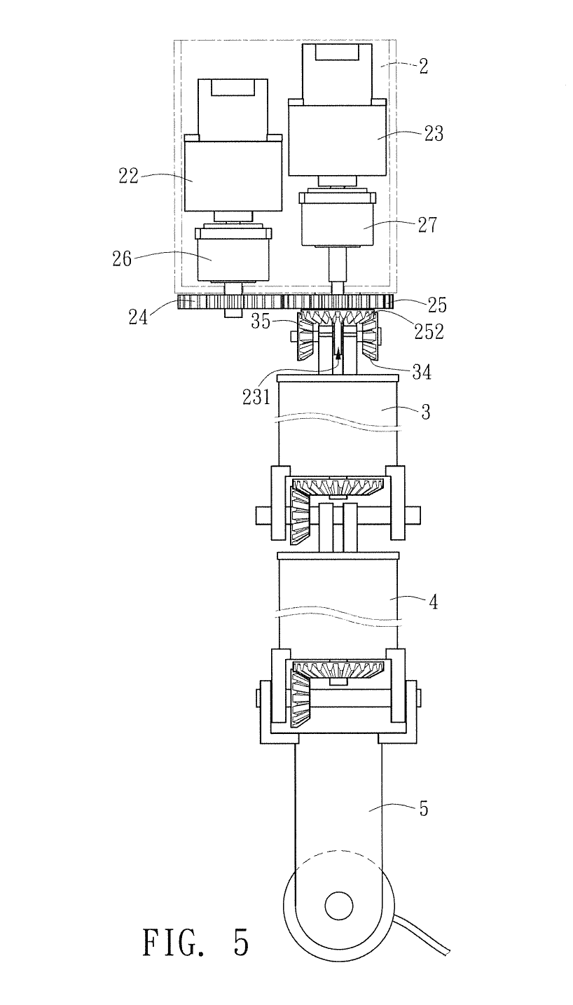

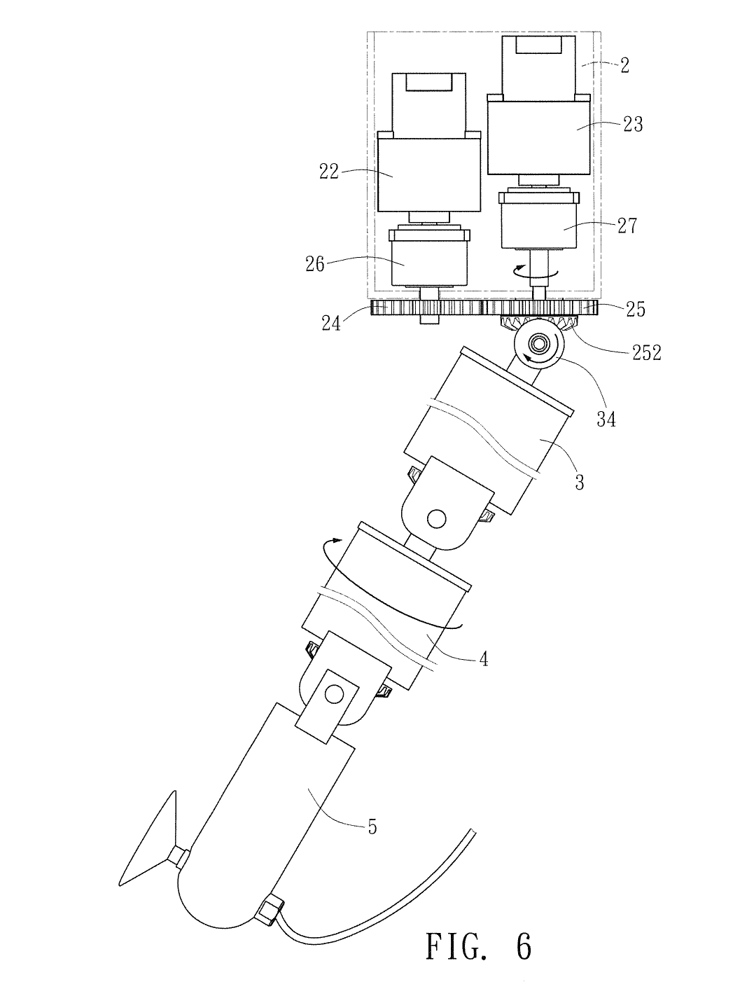

2. In FIGS. 5 and 6, when the first motor 22 is not operated, and the second motor 23 is operated, the rotation of the second transmission shaft 231 is transmitted directly to the parts (including the first middle joint shaft 3, the second middle joint shaft 4 and the end joint shaft 5) connected after the first middle joint shaft 3 to rotate those parts. IN the meantime, the rotation of the first middle joint shaft 3 drives the second bevel gear 34 to rotate on the first bevel gear 252, and the parts after the first middle joint shaft 3 produce a bending movement with respect to the start joint shaft 2, and such movement simultaneously produces the rotating and bending movements of the robotic finger A of the end effector.

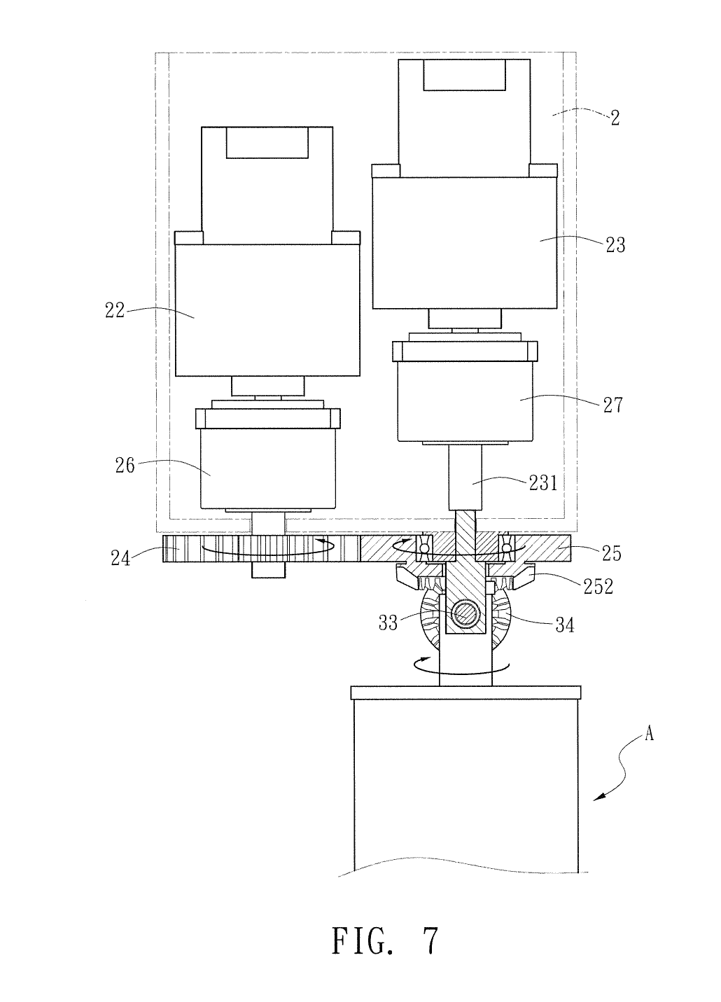

3. In FIG. 7, if it is necessary to produce a rotation of the robotic finger A of the end effector only, then both first motor 22 and second motor 23 must be turned on, and the operation is the same as described above, so that the second motor 23 can drive the robotic finger A directly to produce a rotation, and then the speed reducers 26, 27 of the two motors 22, 23 appropriately adjust the rotation speed of the pivots 33 of the second transmission shaft 231 and the first middle joint shaft 3 to obtain equal rotation speeds of the two, so that the second bevel gear 34 can be rotated idly without driving the parts after the first middle joint shaft 3 to turn pivotally or bend. Therefore, only the robotic finger A is rotated during the overall movement of the end effector.

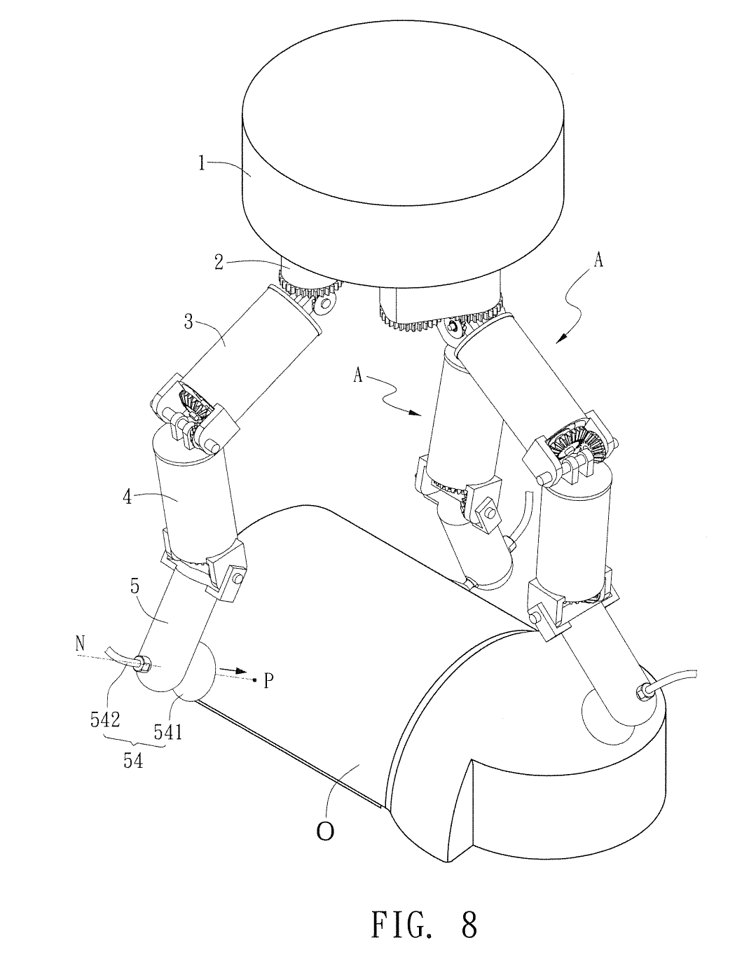

The aforementioned three ways of movements can control the robotic fingers of the end effector to rotate or bend, so that each robotic finger is a module with the movement of four degrees of freedom, and the three joint shafts can control the rotation of the gears by separate motors to fine-tune the position of the suction device installed at the end joint shaft, and the robotic finger can be moved precisely to the normal direction N of a selected suction point P on a surface of a clamped object O as shown in FIG. 8 and approaches along the normal direction N to suck the object, so as to clamp and suck the object securely without the risk of falling out. In addition, the movement of each robotic finger A has four degrees of freedom, so that the end effector of the present invention provides a combination of different clamping directions and thus is suitable for clamping and sucking various objects with different oriented surfaces to improve the applicability and the clamping effect of the end effector.

In addition, the suction device 54 includes a sucker 541 and a circuit 542, and the movement is the same as described above. In the robotic finger A of the end effector having four degrees of freedom, the sucker 541 can approaches along the normal direction of the selected suction point on the surface of the object, and the circuit 542 controls the sucker 541 to suck the object. The suction device 54 can be operated with two modes as described below 1. The sucker 541 of the suction device 54 is comprised of electromagnets for sucking a magnetic conductive object. After the suction device 54 is moved to an appropriate position of the clamping object, current is passed through the circuit 542 to produce magnetism to the sucker 541, so that magnetic forces so produced can suck the clamped object O securely 2.

The circuit 542 of the suction device 54 is an air duct instead, wherein the air duct can blow and suck air to produce suction to the sucker 541 to suck the clamped object O. When the air duct sucks air, the air pressure inside the sucker 541 is reduced to produce a suction to the clamped object O. Further, the suction device 54 can apply the Bernoulli's Law. When the air duct blows air to the clamped object O, the airflows flow through the surfaces of the clamped object O in different speeds to produce a pressure difference so as to produce a force to push the clamped object O towards the sucker 541 and attach the sucker 541 onto the clamped object O.

1. An end effector module, comprising:
a palm base;
a plurality of robotic fingers, extended from a same side of the palm base, and each robotic finger being formed by sequentially and pivotally coupling a start joint shaft, a first middle joint shaft, a second middle joint shaft and an end joint shaft with each other, wherein;
the start joint shaft has a first driving mechanism for driving the first middle joint shaft to turn pivotally about a start joint axis and an axis line substantially normal to said start joint axis for bending with respect to the start joint shaft, as well as driving the first middle joint shaft to turn the second middle joint shaft and the end joint shaft altogether,
the first middle joint shaft has a second driving mechanism for driving the second middle joint shaft to turn pivotally for bending with respect to the first middle joint shaft about an axis line substantially normal to a central axis line of said first middle joint shaft;
the second middle joint shaft has a third driving mechanism for driving the end joint shaft to turn pivotally for bending with respect to the second middle joint shaft about an axis line substantially normal a central axis line of said middle joint shaft;
the end joint shaft has a suction device installed thereon, said suction device including a sucker and an air duct and the air duct blows and sucks air so that the sucker produces a suction to the clamped object;
thereby, each robotic finger is able to adjust the position of the suction device of the end joint shaft through the rotation of the robotic finger and the pivotal turning of each joint shaft for bending with respect to each other, so as to move the suction device to the normal direction of a selected suction point of a surface of a clamped object and approach along the normal direction to suck the object.

2. The end effector module of claim 1, wherein the suction device includes a sucker comprised of electromagents, and an electric current is supplied to the sucker to produce a magnetic force to the clamped object.

3. (canceled)

4. The end effector module of claim 1, wherein the first driving mechanism includes a first motor and a second motor installed on the start joint shaft, and the first motor has a first transmission shaft, and the second motor has a second transmission shaft, and the first transmission shaft is axially coupled to an active gear, and the second transmission shaft is pivotally coupled to a passive gear by a bearing, and the active gear and the passive gear are engaged with each other, and the passive gear has a first bevel gear installed thereon, and the second transmission shaft is passed through the passive gear and first bevel gear to form a connecting end, and the connecting end has a pivot hole penetrating through the connecting end, and a connecting portion is disposed at an end of the first middle joint shaft, and a pivot is transversally fixed to the connecting portion, and passed through and rotated in the pivot hole of the second transmission shaft to drive the first middle joint shaft to turn pivotally, and a second bevel gear is installed at an end of the pivot and engaged with the first bevel gear, and the second bevel gear is driven by the first motor and rotated by the rotation of the first transmission shaft, the active gear, the passive gear and the first bevel gear to drive the pivot to turn the first middle joint shaft pivotally.

5. The end effector module of claim 4, wherein the pivot of the connecting portion of the first middle joint shaft is passed into the pivot hole of the connecting end of the second transmission shaft by a bearing.

6. The end effector module of claim 4, wherein the pivot disposed at the connecting portion of the first middle joint shaft has a seventh bevel gear pivotally coupled to an end opposite to the second bevel gear and engaged with the first bevel gear, and the seventh bevel gear is driven by the first bevel gear to rotate the pivot idly.

7. The end effector module of claim 4, wherein each of the first motor and the second motor is coupled to a speed reducer and further coupled to the corresponding gear.

8. The end effector module of claim 1, wherein the second driving mechanism includes a third motor installed at the first middle joint shaft and having a third bevel gear, and the first middle joint shaft has a pivoting portion disposed proximate to the third bevel gear, and a connecting portion is disposed at an end of the second middle joint shaft and having a transverse pivot, and the pivot of the second middle joint shaft is passed through the pivoting portion of the first middle joint shaft, and the pivot has a fourth bevel gear engaged with the third bevel gear, so that the rotation of the third bevel gear drives fourth bevel gear to rotate the pivot of the second middle joint shaft, so as to turn the second middle joint shaft pivotally,

9. The end effector module of claim 8, wherein the third motor is coupled to a speed reducer and further coupled to the third bevel gear.

10. The end effector module of claim 1, wherein the third driving mechanism includes a fourth motor installed at the second middle joint shaft and having a fifth bevel gear, and the second middle joint shaft has a pivoting portion disposed at a position proximate to the fifth bevel gear, and a connecting portion is disposed at an end of the end joint shaft, and the connecting portion has a transverse pivot installed thereon, and the pivot of the end joint shaft is passed through the pivoting portion of the second middle joint shaft and has a sixth bevel gear engaged with the fifth bevel gear, so that the rotation of the fifth bevel gear drives the sixth bevel gear to rotate the pivot of the end joint shaft, so as to turn the end joint shaft pivotally.

11. The end effector module of claim 10, wherein the fourth motor is coupled to a speed reducer and further coupled to the fifth bevel gear.
